(19) United States
(12) Patent Application Publication
(10) Pub. No.: US 2013/0051826 A1
(43) Pub. Date: Feb. 28, 2013

(54) Image Heating Apparatus

(71) Applicant: Yasuharu Chiyoda, Nagareyama-shi (JP)

(72) Inventor: Yasuharu Chiyoda, Nagareyama-shi (JP)

(73) Assignee: CANON KABUSHIKI KAISHA, Tokyo (JP)

(21) Appl. No.: 13/558,671

(22) Filed: Jul. 26, 2012

(30) Foreign Application Priority Data
Aug. 23, 2011 (JP) 2011-181177

(51) Int. Cl. G03G 15/20

(52) U.S. Cl. 399/45; 399/323; 399/69

(57) ABSTRACT

An image heating apparatus including: an image heating member configured to heat an image on a sheet; a heating device configured to heat the image heating member so that a temperature of the image heating member is kept to a target temperature; an air blowing device configured to blow an air toward the image heating member when a predetermined sheet is separated from the image heating member; and an actuating device configured to actuate the air blowing device to cool the image heating member by blowing the air when the target temperature of the image heating member is lowered.

### BACKGROUND OF THE INVENTION

1. Field of the Invention

The present invention relates to an image heating apparatus configured to heat an image on a sheet. The image heating apparatus may be used as a fixing device in an image forming apparatus such as a copier, a printer, a facsimile (FAX), and a multifunction peripheral (MFP) having multiple forgoing functions.

2. Description of the Related Art

In recent years, there has been such a demand that an electrophotographic image forming apparatus can form an image on a recording medium (sheet) that is thinner than a conventional recording medium.

When an image is formed on such a thin recording medium, an undesired phenomenon may occur such that the recording medium heated and pressurized by a fixing device (image heating apparatus) is wrapped around a fixing member (image heating member) and is not separated from the fixing member. Such a problem similarly occurs when a borderless image having no margin on a leading edge portion of the recording medium is formed.

To cope with the problem, an apparatus described in Japanese Patent Application Laid-Open No. 2007-178732 includes an air blowing device configured to blow an air toward the fixing member so that the recording medium output from a fixing nip can be separated easily without being wrapped around the fixing member.

By the way, a method of changing a controlled temperature (target temperature) of the fixing member in accordance with a type of the recording medium is employed to satisfy fixing performance. In this case, when the temperature of the fixing member is changed from a high controlled temperature to a low controlled temperature, an image forming operation needs to be interrupted to enter a standby state until the temperature of the fixing member is dropped down to the low controlled temperature. Such a standby time may lower user satisfaction.

To cope with the problem, an apparatus described in Japanese Patent Application Laid-Open No. 2000-47521 includes a dedicated air blowing device configured to cool the fixing member so that the dedicated air blowing device cools the fixing member when the temperature of the fixing member is changed from a high controlled temperature to a low controlled temperature.

As described above, when the air blowing device configured to separate the recording medium from the fixing member and the air blowing device configured to lower the controlled temperature of the fixing member are separately provided to perform the two functions, the image heating apparatus is inevitably upsized.

### SUMMARY OF THE INVENTION

The present invention provides an image heating apparatus configured to perform two functions, that is, a function of separating a sheet from an image heating member and a function of lowering a target temperature of the image heating member, without upsizing the image heating apparatus.

An image heating apparatus includes: an image heating member configured to heat an image on a sheet; a heating device configured to heat the image heating member so that a temperature of the image heating member is kept to a target temperature; an air blowing device configured to blow an air toward the image heating member when a predetermined sheet is separated from the image heating member; and an actuating device configured to actuate the air blowing device to cool the image heating member by blowing the air when the target temperature of the image heating member is lowered.

Further features of the present invention will become apparent from the following description of exemplary embodiments with reference to the attached drawings.

### BRIEF DESCRIPTION OF THE DRAWINGS

FIG. 1 is an explanatory diagram illustrating a configuration of an image forming apparatus.

FIG. 2 is an explanatory diagram illustrating a configuration of a fixing device.

FIG. 3 is a block diagram illustrating a control system of the image forming apparatus.

FIG. 4 is an external perspective view of a blowing device.

FIG. 5 is an explanatory graph showing performance of cooling a fixing roller by an air separation unit.

FIG. 6 is a flowchart illustrating cooling control of the fixing roller according to Embodiment 1.

FIG. 7 is an explanatory graph showing a relationship between a temperature difference and an air flow rate according to Embodiment 2.

### DESCRIPTION OF THE EMBODIMENTS

Exemplary embodiments of the present invention will be described in detail with reference to the accompanying drawings. Note that, a part or whole of components of the embodiments can be substituted with known alternative components within the scope of the spirit of the present invention, that is, to shorten a transition time (standby time, a time period during which an image cannot be formed) required to lower a target temperature of an image heating member (fixing roller) by using an air blowing device configured to separate a recording medium (sheet) from the image heating member.

An image heating apparatus is not limited to a fixing device built in an image forming apparatus, but may be a separate image heating apparatus. The image heating member is not limited to a roller member described later, but may be a belt member. A heating device configured to heat the image heating member is not limited to a halogen heater described later, but may be a heating device of an electromagnetic induction heating type.

(Image Forming Apparatus)

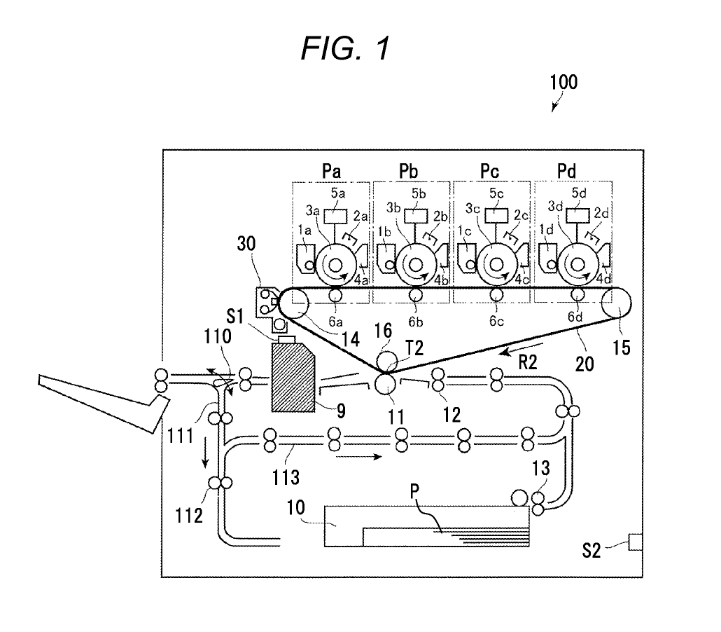

FIG. 1 is an explanatory diagram illustrating a configuration of a printer as an electrophotographic color image forming apparatus. As illustrated in FIG. 1, an image forming apparatus 100 is a full-color printer of a tandem intermediate transfer type in which image forming portions Pa, Pb, Pc, and Pd of yellow, magenta, cyan, and black are arranged along an intermediate transfer belt 20. Note that, the image forming apparatus 100 is not limited to the above-mentioned image forming apparatus, but may be a monochrome image forming apparatus. In addition, the image forming apparatus may be changed to an image forming apparatus for various applications, such as a copying machine, a facsimile, and a multifunction peripheral, by adding necessary devices, equipment, and casing structure.

In the image forming portion Pa, a yellow toner image is formed on a photosensitive drum 3a and is then transferred to the intermediate transfer belt 20. In the image forming portion Pb, a magenta toner image is formed on a photosensitive drum 3b and is then transferred to the intermediate transfer belt 20. Similarly, in the image forming portions Pc and Pd, a cyan toner image and a black toner image are formed on photosensitive drums 3c and 3d, respectively, and are then transferred to the intermediate transfer belt 20.

A recording medium (sheet) P is picked up from a recording medium cassette 10, is separated one by one by a separation roller 13, and stands by at registration rollers 12. The recording medium P is then fed to a secondary transfer portion T2 by the registration rollers 12, and the toner images are transferred from the intermediate transfer belt 20 to the recording medium P. The recording medium P to which the toner images of the four colors are transferred is conveyed to a fixing device 9, and after the toner images are fixed to a surface of the recording medium P by heat and pressure of the fixing device 9. Thereafter, the recording medium P is discharged and stacked on a discharge tray provided outside the image forming apparatus 100.

The above description is intended for simplex printing. On the other hand, in the case of duplex printing, after the toner images are transferred to the surface of the recording medium P at the secondary transfer portion T2 and the toner images are fixed to the surface of the recording medium P by the fixing device 9 that functions as an image heating apparatus, the recording medium P is conveyed to a reverse path 111 by being guided by a flapper 110. The recording medium P is switched back by reverse rollers 112, is guided to a duplex path 113 in a state in which the front and back surfaces of the recording medium P are reversed, and stands by again at the registration rollers 12. The toner images are transferred to the back surface of the recording medium P as well at the secondary transfer portion T2, and after the toner images are fixed to the back surface of the recording medium P by the fixing device 9, the recording medium P is discharged and stacked on the discharge tray provided outside the image forming apparatus 100.

The image forming portions Pa, Pb, Pc, and Pd have substantially the same configuration except that the colors of the toner used in developing devices 1a, 1b, 1c, and 1d are different from one another, that is, yellow, magenta, cyan, and black, respectively. Hereinafter, the image forming portion Pa is mainly described, and the description thereof applies to the image forming portions Pb, Pc, and Pd by substituting the suffix “a” at the end of the reference symbol with the suffix “b”, “c”, or “d” in the description below. The color toner images are formed on the recording medium P in a superimposed manner with predetermined margins on all four sides of the recording medium P. The margin of the leading edge portion is about 2 mm to 3 mm.

In the image forming portion Pa, a corona charging device 2a, an exposure device 5a, the developing device 1a, a transfer roller 6a, and a drum cleaning device 4a are arranged around the photosensitive drum 3a. The corona charging device 2a charges a surface of the photosensitive drum 3a to a uniform dark section potential VD by irradiating the surface of the photosensitive drum 3a with charged particles generated by corona discharge. The exposure device 5a scans the surface of the photosensitive drum 3a with a laser beam to lower the dark section potential VD down to a bright section potential VL, thus forming an electrostatic latent image on the photosensitive drum 3a. The developing device 1a develops the electrostatic latent image to form a toner image on the photosensitive drum 3a. The transfer roller 6a to which a direct-current voltage is applied transfers the toner image on the photosensitive drum 3a to the intermediate transfer belt 20. The drum cleaning device 4a collects transfer residual toner that remains on the photosensitive drum 3a without being transferred to the intermediate transfer belt 20.

The intermediate transfer belt 20 is supported by being looped around a driving roller 15, a tension roller 14, and an opposing roller 16, and is driven by the driving roller 15 to rotate in a direction indicated by the arrow R2. A secondary transfer roller 11 abuts on the intermediate transfer belt 20, which is supported by the opposing roller 16 on an inner surface of the intermediate transfer belt 20, and forms the secondary transfer portion T2 for transferring the toner images to the recording medium. The recording medium P is placed over the negatively charged toner images on the intermediate transfer belt 20, and they are passed through the secondary transfer portion T2. During the passing process, a positive voltage is applied to the secondary transfer roller 11 so that the toner images are transferred from the intermediate transfer belt 20 to the recording medium P. A belt cleaning device 30 collects transfer residual toner that remains on the intermediate transfer belt 20 without being transferred to the recording medium P.

(Fixing Device)

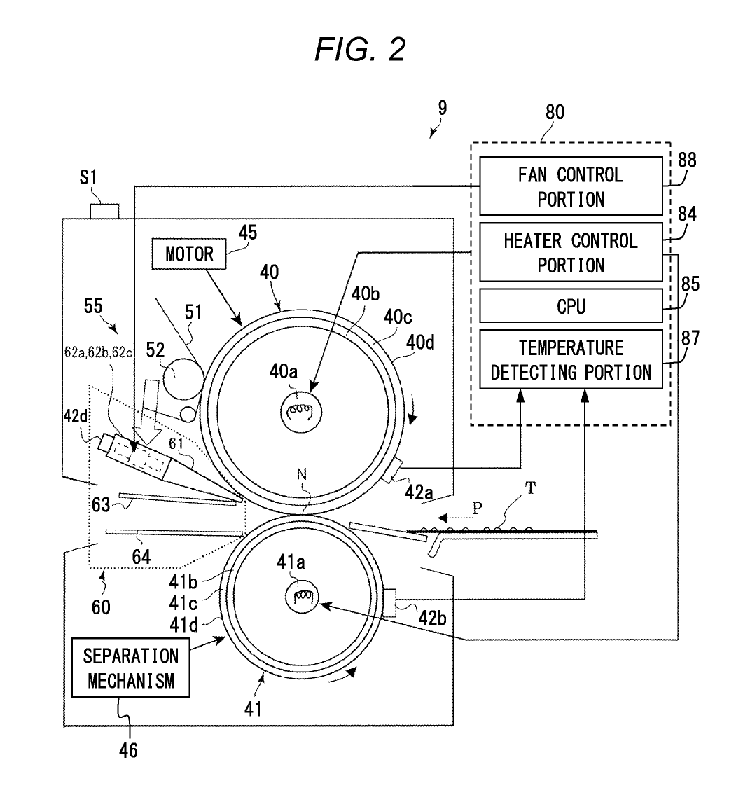

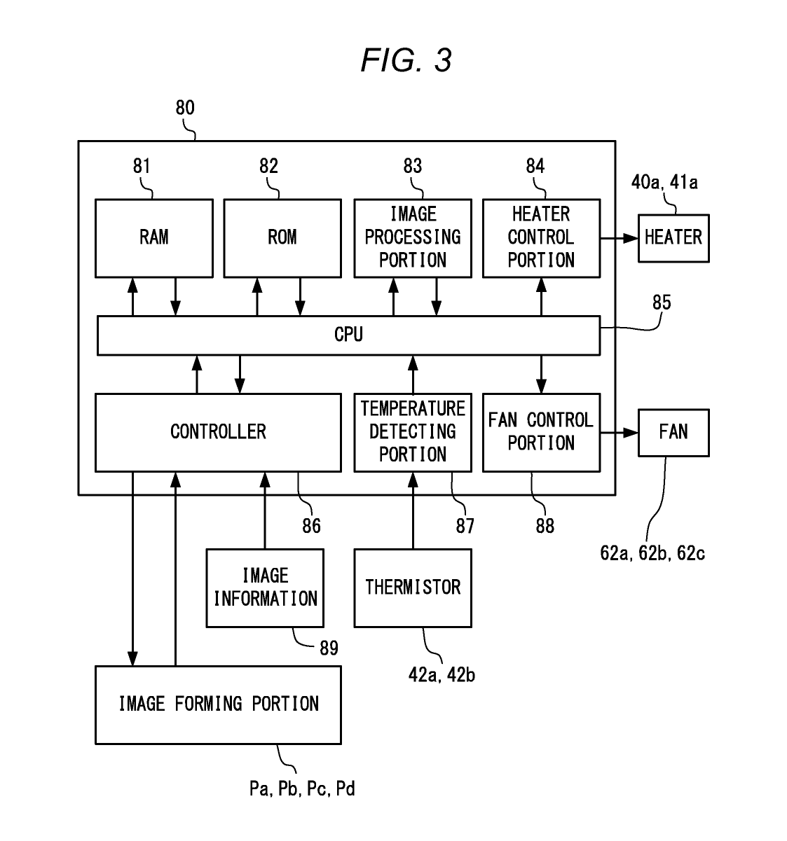

FIG. 2 is an explanatory diagram illustrating a configuration of the fixing device functioning as the image heating apparatus. FIG. 3 is a block diagram illustrating a control system of the image forming apparatus 100.

The fixing device 9 of the embodiment has a function of fixing the toner image to the recording medium by heating and pressurizing the toner image on the recording medium at a nip portion formed between the image heating member and a pressure member (rotary member).

As illustrated in FIG. 2, the fixing device 9 forms a heating nip N configured to heat the recording medium by bringing a pressure roller (rotary member) 41 into pressure contact with a fixing roller (image heating member) 40 from below. A motor 45 rotates the fixing roller 40 in a clockwise direction, and at the same time, rotates the pressure roller 41 in a counterclockwise direction.

The recording medium P on which the toner image T has been formed at the secondary transfer portion T2 illustrated in FIG. 1 is nipped and conveyed at the heating nip N formed by the fixing roller 40 and the pressure roller 41. The toner fused by heat and pressure at the heating nip N, output from the heating nip N, and then cooled by the outside air is fixed to a surface texture of the recording medium. Thus, the toner image is fixed to the recording medium.

As illustrated in FIG. 2, the fixing roller 40 is a hollow cylindrical member having an outer diameter of 80 mm, and includes a lamp heater 40a functioning as a heating device inside the cylindrical member. The fixing roller 40 is obtained by forming an elastic layer 40c made of silicone rubber on an outer circumferential surface of a cored bar 40b that is formed into a cylindrical shape and made of aluminum, iron, or the like. An outer circumferential surface of the elastic layer 40c is covered with a release layer 40d formed of a tube made of a fluorine resin such as tetrafluoroethylene-perfluoroalkylvinyl ether copolymer (PFA) or polytetrafluoroethylene (PTFE).

The pressure roller 41 is a hollow cylindrical member having an outer diameter of 60 mm, and includes a lamp heater 41a functioning as a heating device inside the cylindrical member. The pressure roller 41 is obtained by forming an elastic layer 41c made of silicone rubber on an outer circumferential surface of a cored bar 41b which is formed into a cylindrical shape and made of aluminum, iron, or the like. An outer circumferential surface of the elastic layer 41c is covered with a release layer 41d formed of a tube made of a fluorine resin such as PFA or PTFE.

The pressure roller 41 is brought into pressure contact with the fixing roller 40 with a total pressure of about 784 N (about 80 kgf) by being biased upward by a biasing mechanism disposed at each of the both end portions in a direction of a rotational axis. The pressure roller 41 is brought into abutment with and separable from the fixing roller 40. A separation mechanism 46 raises and lowers the both end portions of the pressure roller 41 with a cam mechanism, thus bringing the pressure roller 41 into contact with the fixing roller 40 and separating the pressure roller 41 from the fixing roller 40.

A thermistor 42b as a temperature detecting unit is arranged to abut on a surface of the pressure roller 41. A surface temperature of the pressure roller 41 is detected by the thermistor 42b, and the detected surface temperature of the pressure roller 41 is input to a temperature detecting portion 87 of a control portion 80. A heater control portion 84 controls ON and OFF of the lamp heater 41a to keep the surface temperature of the pressure roller 41 to 120±5° C.

The fixing roller 40 has substantially the same temperature at a center portion and end portions in the direction of the rotational axis. A thermistor 42a as a temperature detecting unit is arranged near the center portion of the fixing roller 40 in the direction of the rotational axis at a position upstream of the heating nip N in a rotation direction of the fixing roller 40, and detects a surface temperature of the fixing roller 40 moving toward the heating nip N. The thermistor 42a is a temperature detecting element of a contact type, and inputs an output corresponding to the surface temperature of the fixing roller 40 to the control portion 80.

The control portion 80 controls ON and OFF of the lamp heater 40a so that the surface temperature of the fixing roller 40 detected by the thermistor 42a converges to a predetermined controlled temperature (target temperature). When the detected temperature is lower than the controlled temperature of the fixing roller 40 thus set, power is supplied to the lamp heater 40a and the lamp heater 40a is turned ON. On the other hand, when the detected temperature is higher than the controlled temperature of the fixing roller 40 thus set, power supply to the lamp heater 40a is stopped and the lamp heater 40a is turned OFF.

In order to accommodate different types of recording media, the control portion 80 sets the controlled temperature (target temperature) in accordance with the type (basis weight) of the recording medium in a range from 135° C. to 200° C., as shown in Table 1.

TABLE 1

| Basis weight of | | |
|---|---|---|
| recording medium | | |
| (g/m²) | Fixing roller | Air separation |
| up to 79 | 135° C. | ON |
| 80 to 128 | 150° C. | ON |
| 129 to 150 | 170° C. | ON |
| 151 to 209 | 170° C. | OFF |
| 210 to 256 | 185° C. | OFF |
| 257 to 300 | 200° C. | OFF |

As shown in Table 1, in a state in which the surface temperature (detected temperature) of the fixing roller 40 is maintained to the controlled temperature, image formation (fixing process) can be performed on 60 sheets of recording media per minute regardless of the type (basis weight) of the recording medium.

(Blowing Device)

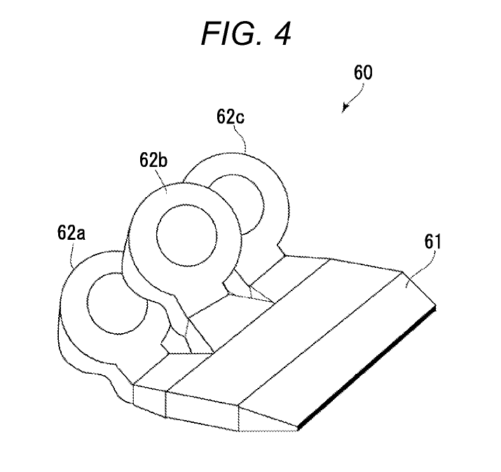

FIG. 4 is an external perspective view of a blowing device. In the fixing device, the unfixed toner image formed on the recording medium is brought into direct contact with the surface of the fixing roller, and hence the recording medium adheres to the fixing roller due to a viscosity of the fused toner, possibly causing a phenomenon that the recording medium is not separated from the fixing roller and cannot be conveyed further. To cope with the problem, the embodiment employs the following method. That is, an air separation unit as an example of the blowing device is arranged on a downstream side of the heating nip N in a direction of conveying the recording medium, and by blowing an air toward the fixing roller, the recording medium is separated from the fixing roller forcibly.

In recent years, it has been demanded to form an image on various recording media such as a thick paper sheet, a thin paper sheet, a cloth, and a resin sheet, as well as a plain paper sheet. The image forming apparatus is required to increase heating performance of heating the recording medium by increasing a diameter of the fixing roller to accommodate both a thin paper sheet having a small heat capacity and a thick paper sheet having a large heat capacity and to attain a high productivity by achieving sufficient fixing performance of the toner even for the thick paper sheet.

However, when the diameter of the fixing roller is increased, a recording medium such as the thin paper sheet is unlikely to be separated from the fixing roller by self-stripping. The recording medium such as the thin paper sheet then possibly adheres to the fixing roller by the viscosity of liquid generated when the unfixed toner image is brought into contact with the fixing roller and fused, and may be wrapped around the fixing roller on an output side of the heating nip N without being separated from the fixing roller by self-stripping, thus causing a recording medium jam.

To cope with the problem, in the image forming apparatus 100, an air separation unit 60 is arranged on the output side of the heating nip N. In order to solve the problem that the recording medium of a thin paper sheet adheres to the fixing roller 40 and cannot be separated from the fixing roller 40, the air separation unit 60 separates the recording medium from the fixing roller 40 forcibly by blowing an air toward the leading edge of the recording medium.

As illustrated in FIG. 2, the air separation unit 60 is arranged on the downstream side of the heating nip N of the fixing device 9 in the conveyance direction. The air separation unit 60 includes guide plates 63 and 64 arranged on the downstream side of the heating nip N in the conveyance direction, for guiding discharge of the recording medium P. An opening portion at a tip of a flow path forming member 61 is arranged at a position close to the surface of the fixing roller 40. An air sent from an air blowing fan 62 is blown toward the heating nip N through the flow path forming member 61. Through blowing of the air toward the leading edge of the recording medium P having the toner image fixed at the heating nip N, the recording medium P adhering to the fixing roller 40 is separated from the fixing roller 40.

As illustrated in FIG. 4, the air separation unit includes a nozzle having an outlet opened toward a circumferential surface of the fixing roller 40. The outlet of the nozzle is opened in a continuous manner opposite to a generating line of the circumferential surface of the fixing roller 40. The air separation unit combines airs respectively generated by three air blowing fans 62a, 62b, and 62c in the common flow path forming member (nozzle) 61, and blows the air toward a sheet passing range of the recording medium in the direction of the rotational axis of the fixing roller 40 with a substantially uniform air flow distribution.

However, an application range of the air separation unit 60 may be switched appropriately between a case of blowing the air and a case of not blowing the air, even for the recording media having an equivalent basis weight, in accordance with adjustment of glossiness of an output image (gloss control) or with a physical condition of the recording medium P.

In addition, when the air separation unit 60 is constantly actuated, there is room for improvement in terms of a temperature decrease of the fixing roller 40 and waste of power (non-energy saving). To solve the problem, in principle, the control portion 80 is configured not to blow the air toward the fixing roller 40 for a recording medium that can be easily separated from the fixing roller 40 and does not need separation assist by the air, or in a sheet passing interval between each recording medium.

Even when separation assist by the air is needed, in order to suppress an unnecessary temperature fluctuation of the fixing roller 40, to reduce a fluctuation in glossiness of output images, and to save power for the heating, it is desired to blow a minimum necessary air volume to the fixing roller 40. For this reason, the control portion 80 sets, in accordance with those purposes, an air volume and ON and OFF of the air blowing when the air is blown to the fixing roller 40 on the output side of the heating nip N, and thus blows the air toward the fixing roller 40 in a flexible and prompt manner. Through change of an air pressure in accordance with the basis weight of the recording medium, the control portion 80 can stably prevent the recording medium from adhering to and wrapping around the fixing roller 40.

A fan control portion 88 is capable of setting rotation speeds of the air blowing fans 62a, 62b, and 62c arbitrarily in a range from 100 rpm to 3,400 rpm. When the air blowing fans 62a, 62b, and 62c are operated at the maximum rotation speed, an air flow rate of about 3 m³/min can be obtained. The fan control portion 88 can vary the air flow rate at the outlet of the flow path forming member 61 from about 0.3 m³/min to about 3.0 m³/min by changing the number of fans to be operated and the rotation speed of each of the air blowing fans 62a, 62b, and 62c.

The air blowing fans 62a, 62b, and 62c normally suck in an outside air surrounding the fixing device 9 and having a temperature of 50° C. to 70° C., and discharge the air toward the flow path forming member 61. The temperature of the air blown from the flow path forming member 61 to the fixing roller 40 is substantially the same as the temperature of the outside air thus sucked in, i.e., 50° C. to 70° C., because the speed of the air is fast enough.

When the temperature of the air blown to the fixing roller 40 is below 50° C., a problem occurs in that the controlled temperature of the fixing roller 40 cannot be maintained in a stable manner in association with the ON and OFF of the air blowing and the change of the air flow rate. On the other hand, when the temperature of the air blown to the fixing roller 40 exceeds 70° C. and approaches the surface temperature of the fixing roller 40, this is not desirable because the cooling effect for the fixing roller 40 is decreased.

It takes about one and a half (1.5) seconds from a start of rotation of the air blowing fans 62a, 62b, and 62c until the rotation speed reaches the maximum speed. Therefore, in a usual operation, the control portion 80 is configured to start the rotation of the air blowing fan 62 about two (2) seconds before the recording medium P arrives at the heating nip N so that a desired air pressure is generated at the outlet of the flow path forming member 61 about half (0.5) second before the arrival.

The control portion 80 calculates, based on a time of image formation at the image forming portions Pa, Pb, Pc, and Pd, a time when the recording medium on which the toner image has been transferred at the secondary transfer portion T2 arrives at the heating nip N of the fixing device 9. The control portion 80 determines a rotation start timing of the air blowing fans 62a, 62b, and 62c two (2) seconds before the calculated time. This is because the minimum condition for separating the recording medium P from the fixing roller 40 is that the air is blown to the fixing roller 40 at a time when the leading edge of the recording medium P has passed through the heating nip N. However, as long as a method capable of estimating a passage timing of the recording medium P through the heating nip N is employed, the time at which the image forming portions Pa, Pb, Pc, and Pd form an image may be controlled by a calculation method based on another reference.

In a basic operation of the air separation unit 60, the air is blown to the fixing roller 40 at the above-mentioned timing only for a recording medium that has a small basis weight and is hard to be separated from the fixing roller 40. When the succeeding recording medium P does not require the air blowing, the control portion 80 stops the air blowing fans 62a, 62b, and 62c at the time when the preceding recording medium P has passed through the heating nip N, to thereby prevent wasteful cooling in the sheet passing interval between the preceding recording medium and the succeeding recording medium.

In the basic operation of the air separation unit 60, if there is a time period of two (2) seconds or longer until the succeeding recording medium P arrives at the heating nip N at the time when the preceding recording medium P has passed through the heating nip N, the control portion 80 stops the air blowing fans 62a, 62b, and 62c. The control portion 80 then causes the air blowing fans 62a, 62b, and 62c to stand by in a stopped state until two (2) seconds before the succeeding recording medium P arrives at the heating nip N.

By the way, in a fixing device of an image forming apparatus for achieving a high productivity for a thick paper sheet as in the case of a thin paper sheet, a heat capacity of the fixing roller 40 is designed to be large in order to improve the productivity of the thick paper sheet. When the fixing roller 40 having a large heat capacity is heated, a time period from a time when the lamp heater 40a in the fixing roller 40 is turned ON to a time when the heat is conducted to an outer surface of the fixing roller 40 is increased. As a result, a time period required to reach the target temperature is increased at the time of heating.

As illustrated in FIG. 2, in the fixing roller 40, a thickness of the cored bar 40b is 3 mm, and a thickness of the elastic layer 40c is 2 mm. However, the elastic layer 40c has a low thermal conductivity and a large heat capacity and the release layer 40d has a low thermal conductivity, and hence the fixing roller 40 requires a certain length of time from a time when the lamp heater 40a is turned ON to a time when a heat amount of the lamp heater 40a increases the surrounding temperature.

When the heat capacity of the elastic layer 40c is reduced by decreasing the thickness thereof and the thermal conductivity of the elastic layer 40c is increased by changing a material thereof, the time period required to increase the temperature of the fixing roller 40 to a new controlled temperature can be shortened. However, there is a limit to shortening of the time period in order to maintain a high speed in passing the recording medium and a high glossiness, and hence a certain amount of delay is unavoidable when the surface temperature of the fixing roller 40 is increased. Therefore, in the fixing device 9 that accommodates both the thin paper sheet having a small heat capacity and the thick paper sheet requiring a large amount of heat and that achieves a high productivity even for the thick paper sheet, when performing a continuous image forming job using the thin paper sheet and the thick paper sheet in a mixed manner, a certain length of time is required to change the controlled temperature of the fixing roller 40. The image forming apparatus 100 requires a certain length of time to change the controlled temperature of the fixing roller 40 when performing a continuous job using the thin paper sheet and the thick paper sheet in a mixed manner.

In the fixing device 9 having multiple controlled temperatures for a wide variety of recording media, rapid cooling of the fixing roller 40 is effective to shorten a downtime. However, when an air cooling device configured to cool the fixing roller is provided separately from the air separation unit 60, a large number of problems occur, such as complication of the device and the control. In order to shorten the downtime (standby time during which the image formation is inevitably interrupted), it is possible to conceive a method of cooling the fixing roller 40 by bringing a metal roller into contact with the fixing roller 40, or a configuration for air-cooling the fixing roller 40 by separately providing a dedicated cooling fan. However, those method and configuration lead to a problem such as complication of the device.

To cope with the above-mentioned problems, in the following examples, the standby time due to interruption of the image formation is shortened by promptly completing the change (decrease) of the controlled temperature (target temperature) of the fixing roller 40 by air-cooling the fixing roller 40 with use of the air separation unit 60 for assisting separation of the recording medium such as a thin paper sheet.

### Embodiment 1

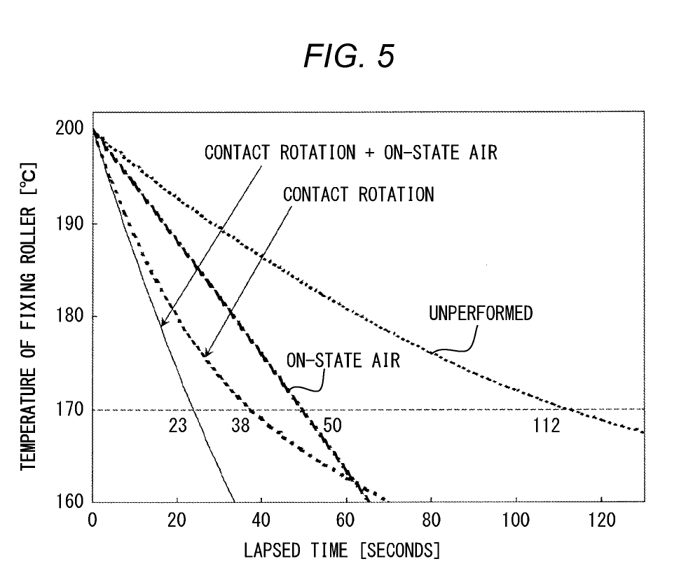

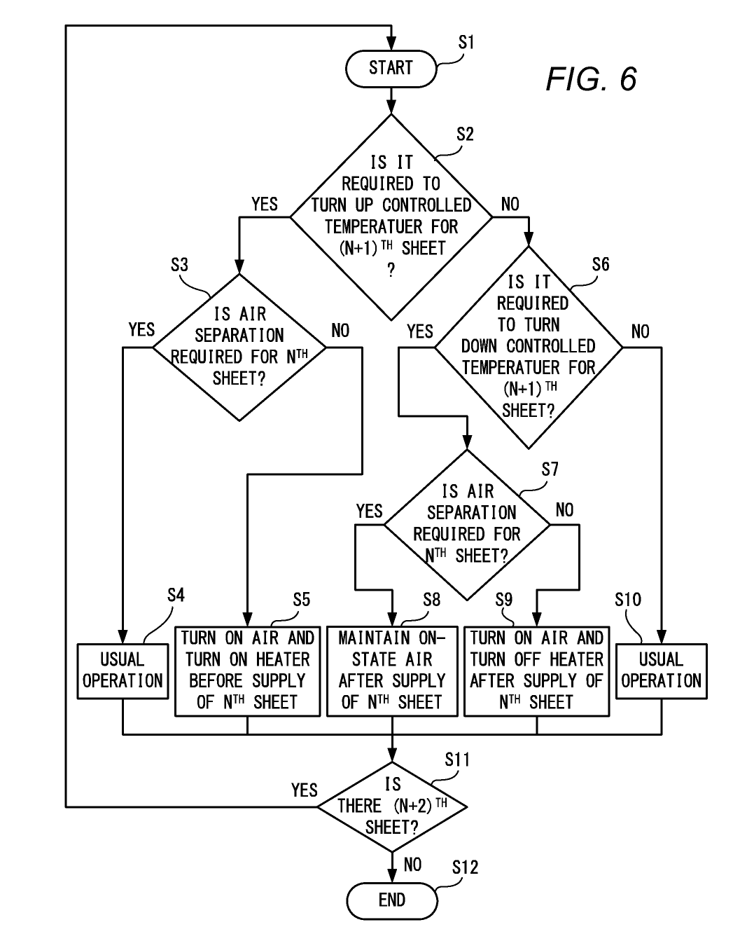

FIG. 5 is an explanatory graph showing performance of cooling the fixing roller by the air separation unit. FIG. 6 is a flowchart illustrating cooling control of the fixing roller according to Embodiment 1.

As illustrated in FIG. 2, the fixing roller 40 abuts on an image surface of the recording medium. The pressure roller 41 forms the heating nip N for the recording medium by abutting on the fixing roller 40. The lamp heater 40a heats the fixing roller 40 to control its temperature to a variable controlled temperature. The secondary transfer roller 11 which is an example of a feeding portion feeds the recording medium to the heating nip N after waiting for the temperature of the fixing roller 40 to be controlled to the controlled temperature.

In a case that meets predetermined conditions in which separation of the recording medium from the fixing roller 40 is difficult, the air separation unit 60 which is an example of the blowing device separates the recording medium from the fixing roller 40 by blowing the air toward the fixing roller 40 on the output side of the heating nip N. When the temperature of the fixing roller is changed from a high controlled temperature to a low controlled temperature in association with change of the type of the recording medium (for example, from a thick paper sheet to a thin paper sheet), the control portion 80 which is an example of a control unit (actuating device) performs air cooling of the fixing roller 40 by actuating the air separation unit 60 configured to separate the recording medium.

As shown in FIG. 5, first, a cooling performance of the fixing roller 40 was compared among various combinations of the ON and OFF of the air separation unit 60 and contact and separation of the pressure roller 41. In the example, a cooling process of the fixing roller 40 was started at 200° C., which was the controlled temperature for the recording medium having a basis weight of 300 g/m², and the temperature of the fixing roller 40 which decreased with a lapse of time was measured.

In FIG. 5, the line indicated by “UNPERFORMED” represents temperature change resulting only from natural cooling with the lamp heater 40a being in the OFF-state. However, air flow in the main body is activated. In this case, a time period of one hundred and twelve (112) seconds was required to decrease the temperature from 200° C. to 170° C. On the other hand, the line indicated by “ON-STATE AIR” represents temperature change when the air separation unit 60 was continuously maintained in the ON-state. In this case, a time period of fifty (50) seconds was required to decrease the temperature from 200° C. to 170° C. When the cases of “UNPERFORMED” and “ON-STATE AIR” are compared, the cooling time of the fixing roller 40 is considerably shortened in the case of “ON-STATE AIR”.

In FIG. 5, the line indicated by “CONTACT ROTATION” represents temperature change when the pressure roller 41 of which the temperature was controlled to 140° C. was brought into contact with the fixing roller 40 and idling rotation was performed. In this case, a time period of thirty-eight (38) seconds was required to decrease the temperature from 200° C. to 170° C. The line indicated by “CONTACT ROTATION+ON-STATE AIR” represents temperature change when the air separation unit 60 was turned ON and the pressure roller 41 of which the controlled temperature (target temperature) (for example, 140° C.) is set to a temperature lower than that of the fixing roller 40 was brought into contact with the fixing roller 40 and idling rotation was performed. In this case, a time period of merely twenty-three (23) seconds was required to decrease the temperature from 200° C. to 170° C. In the following description, only the case of “CONTACT ROTATION” is described as a comparative example, and the case of “CONTACT ROTATION+ON-STATE AIR” is described as Embodiment 1.

As illustrated in FIG. 6 with reference to FIG. 3, the control portion 80 executes a combination image forming job by controlling each unit of the image forming apparatus 100.

When the image forming apparatus 100 receives the image forming job, the control portion 80 sends information on the image forming job to a CPU 85 in a sequential manner via a controller 86 (Step S1). The control portion 80 receives information on the type of the recording medium together with image information, and formulates a temperature control schedule for the entire job based on the information on the type of the recording medium and the sequence for all the sheets in the image forming job. The control portion 80 stores the temperature control schedule in a RAM 81, and starts the temperature control in a predictive manner at a time of one or two sheets back from the currently passing recording medium, to thereby reduce a standby time after the temperature of the fixing roller 40 is converged. The control portion 80 delivers the information on the controlled temperature to the heater control portion 84 and instructs the fan control portion 88 for the ON and OFF of the air separation in accordance with the temperature control schedule.

The control portion 80 recognizes that a recording medium of 135 g/m² comes as an N^{th} sheet, and therefore determines from Table 1 to set the air separation to “ON” and the controlled temperature to “170° C.”, and transfers each piece of information in time for a passing timing of the N^{th} recording medium.

The control portion 80 determines “whether or not it is required to turn up the controlled temperature for the subsequent (N+1)^{th} recording medium with respect to the current controlled temperature” at a stage in which the N^{th} recording medium has not arrived at the heating nip N (Step S2).

Even when the recording medium for which the controlled temperature is to be changed does not meet a predetermined condition, the control portion 80 performs air-cooling of the fixing roller 40 by the air separation unit 60 from a time before the recording medium for which the controlled temperature is to be changed arrives at the heating nip N to a time when this recording medium passes through the heating nip N. When a recording medium immediately preceding the recording medium for which the controlled temperature is to be changed does not meet the predetermined condition, the control portion 80 changes the controlled temperature to a lower temperature immediately after the recording medium immediately preceding the recording medium for which the controlled temperature is to be changed passes through the heating nip N, and starts actuating the air separation unit 60. On the other hand, when the recording medium immediately preceding the recording medium for which the controlled temperature is to be changed meets the predetermined condition, the control portion 80 actuates the air separation unit 60 before the recording medium immediately preceding the recording medium for which the controlled temperature is to be changed arrives at the heating nip N, and changes the controlled temperature to a lower temperature immediately after the recording medium immediately preceding the recording medium for which the controlled temperature is to be changed has passed through the heating nip N.

Specifically, when the (N+1)^{th} recording medium requires control of temperature to be higher than that of the N^{th} recording medium (YES in Step S2), the control portion 80 determines whether or not the current N^{th} recording medium requires air separation (Step S3).

When it is determined that the N^{th} recording medium is of 150 g/m² or less and requires the air separation (YES in Step S3), the control portion 80 executes a usual operation (Step S4). As described above, in the usual operation, the air separation unit 60 is turned ON two (2) seconds before the recording medium requiring the air separation arrives at the heating nip N, and turned OFF when the recording medium requiring the air separation has passed through the heating nip N.

On the other hand, when it is determined that the N^{th} recording medium does not require the air separation (NO in Step S3), the control portion 80 continues the current temperature control by turning ON the air separation unit 60 and turns ON the lamp heater 40a (Step S5). The control portion 80 starts the air blowing at a stage in which the fixing operation of the N^{th} recording medium is not still performed, to thereby temporarily suppress a temperature increase on the surface of the fixing roller 40 (Step S5).

The subsequent (N+1)^{th} recording medium requires an increase of the controlled temperature, and hence the control portion 80 turns ON the heater earlier to increase the internal temperature while keeping the surface of the fixing roller 40 to a low temperature, and promptly increases the temperature to a new controlled temperature after the N^{th} recording medium has passed through the heating nip N. In other words, even when the timing of turning ON the lamp heater 40a is too early, the temperature of the fixing roller 40 is maintained to the controlled temperature for the N^{th} recording medium at the time of fixing the N^{th} recording medium through air cooling of the air separation unit 60. Through the air cooling of the air separation unit 60, it is possible to avoid an image defect or a non-uniform glossiness due to an excessively high temperature of the fixing roller 40 at the time of fixing the N^{th} recording medium. An output image in which a constant glossiness is maintained can be obtained even when the lamp heater 40a is turned ON, and a time period until the temperature reaches the controlled temperature for the subsequent (N+1)^{th} recording medium can be shortened.

When the controlled temperature of the (N+1)^{th} recording medium is not higher than that of the N^{th} recording medium (NO in Step S2), the control portion 80 determines whether or not the controlled temperature of the (N+1)^{th} recording medium is lower than that of the N^{th} recording medium (Step S6).

When the controlled temperature of the (N+1)^{th} recording medium is not lower than that of the N^{th} recording medium (NO in Step S6), the control portion 80 executes the usual operation while maintaining the same controlled temperature for the N^{th} recording medium because the N^{th} recording medium and the (N+1)^{th} recording medium have the same controlled temperature (Step S10).

When the controlled temperature is changed to a higher temperature during continuous passing of the recording medium, the control portion 80 performs air-cooling of the fixing roller 40 by the air separation unit from a time before the recording medium immediately preceding the preceding recording medium arrives at the heating nip N to a time when the recording medium immediately preceding the preceding recording medium passes through the heating nip N. Even when the recording medium immediately preceding the recording medium for which the controlled temperature is to be changed does not meet the predetermined condition, the air separation unit 60 blows the air toward the fixing roller 40 to separate the recording medium. The control portion 80 changes the controlled temperature to a higher temperature by starting actuation of the air separation unit 60 immediately after a second recording medium preceding the recording medium for which the controlled temperature is to be changed has passed through the heating nip N, and stopping the air separation unit 60 immediately after the recording medium immediately preceding the recording medium for which the controlled temperature is to be changed has passed through the heating nip N.

Specifically, when the controlled temperature of the (N+1)^{th} recording medium is lower than that of the N^{th} recording medium (YES in Step S6), the control portion 80 determines whether or not the current N^{th} recording medium requires air separation (Step S7).

When the N^{th} recording medium requires the air separation (YES in Step S7), the control portion 80 starts the air cooling of the fixing roller 40 by turning ON the air separation unit 60 two (2) seconds before the N^{th} recording medium arrives at the heating nip N. When the controlled temperature is changed immediately after the N^{th} recording medium has passed through the heating nip N, the lamp heater 40a is turned OFF, and thus the temperature of the fixing roller 40 is decreased sharply along the line indicated by “CONTACT ROTATION+ON-STATE AIR” shown in FIG. 5. When the temperature of the fixing roller 40 is converged to a new low controlled temperature, the (N+1)^{th} recording medium is fed. The control portion 80 turns OFF the air separation unit 60 after waiting for the (N+1)^{th} recording medium to pass through the heating nip N (Step S8).

That is, in the usual operation, the air separation unit 60 is turned OFF at the time when the N^{th} recording medium has passed through the heating nip N. In contrast, in Embodiment 1, the air separation unit 60 is continued to be in the ON state to progress the cooling of the fixing roller 40, thus achieving fast convergence to the new low controlled temperature.

Similarly, when the N^{th} recording medium does not require the air separation (NO in Step S7), the control portion 80 starts the air cooling of the fixing roller 40 by turning ON the air separation unit 60 two (2) seconds before the N^{th} recording medium arrives at the heating nip N. When the controlled temperature is changed immediately after the N^{th} recording medium has passed through the heating nip N, the lamp heater 40a is turned OFF, and the temperature of the fixing roller 40 is decreased sharply along the line indicated by “CONTACT ROTATION+ON-STATE AIR” shown in FIG. 5. When the temperature of the fixing roller 40 is converged to a new low controlled temperature, the (N+1)^{th} recording medium is fed. The control portion 80 turns OFF the air separation unit 60 after waiting for the (N+1)^{th} recording medium to pass through the heating nip N (Step S9). That is, the glossiness of the output image is matched between a case in which the N^{th} recording medium does not require the air separation and a case in which the N^{th} recording medium requires the air separation by reproducing the same thermal state of the fixing roller 40 as in the latter case even when the N^{th} recording medium does not require the air separation.

Note that, in Embodiment 1, the air separation unit 60 is turned ON and the lamp heater 40a is turned OFF immediately after the N^{th} recording medium has passed through the heating nip N. The air separation unit 60 is continued to be in the ON state until the (N+1)^{th} recording medium passes through the heating nip N. However, when the temperature of the fixing roller 40 is decreased below the controlled temperature before the (N+1)^{th} recording medium arrives at the heating nip N, the air flow rate of the air separation unit 60 can be reduced. The air separation unit 60 can be turned OFF. It suffices that the cooling state by the air separation unit 60 is not changed in the middle of the (N+1)^{th} recording medium.

With the configuration of Embodiment 1, the air separation unit 60 functions also as a cooling fan configured to lower the surface temperature of the fixing roller 40.

With the control of Embodiment 1, two or more controlled temperatures are provided for the fixing roller 40, and when the controlled temperature is changed from a high controlled temperature to a low controlled temperature, the air separation unit 60 is operated to cool the fixing roller 40. In addition, after the temperature of the fixing roller 40 is changed from the high controlled temperature to the low controlled temperature, when an image is formed on a recording medium that is hard to separate, such as a thin paper sheet, the air separation unit 60 is operated to separate the recording medium as a recording medium separation assisting mechanism.

With the control of Embodiment 1, two or more controlled temperatures are provided for the fixing roller 40, and when the controlled temperature is changed from a lower controlled temperature to a high controlled temperature, the air separation unit 60 is operated in advance and the lamp heater 40a is turned ON. The air separation unit 60 is turned OFF after the last recording medium having the low controlled temperature has passed through the heating nip N.

### Embodiment 2

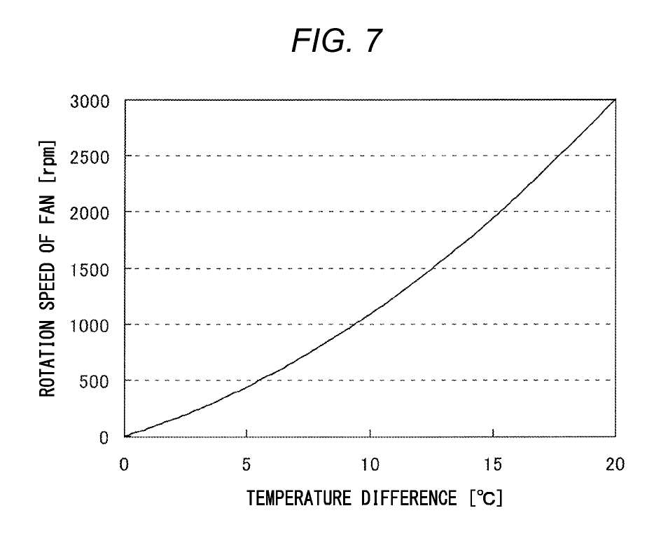

FIG. 7 is an explanatory graph showing a relationship between a temperature difference and an air flow rate according to Embodiment 2 of the present invention. In Embodiment 1, the ON and OFF of the air separation unit 60 is controlled. In Embodiment 2, the air flow rate is changed in accordance with the temperature difference between two controlled temperatures before and after the change. With this control, excessive cooling of the fixing roller by the air separation unit 60 can be avoided by adjusting a speed of the temperature change of the fixing roller.

Embodiment 2 has the same configuration and the same control as Embodiment 1 except that the air flow rate adjustment of the air separation unit 60 in Steps S5, S8, and S9 in the flowchart illustrated in FIG. 6 are added. Therefore, in the following description, matters different from Embodiment 1 are described and redundant description is omitted.

As shown in FIG. 7, there was determined a condition for achieving a uniform glossiness in the resulting product when a high portion of the temperature of the fixing roller 40 with respect to the controlled temperature was corrected through the air blowing of the air separation unit 60. The controlled temperature of the fixing roller 40 was lowered, and at the same time, the air separation unit 60 was turned ON, to thereby cool the fixing roller 40 by the air separation unit 60. When the detected temperature of the thermistor 42a reached the controlled temperature after the change, the toner image was formed in the image forming apparatus 100 illustrated in FIG. 1, and the sheet was fed to the fixing device 9. Such a relationship between the air flow rate and the temperature difference that the glossiness of the output image became a predefined value was determined by changing the temperature difference for lowering the controlled temperature and the air flow rate of the air separation unit 60.

As shown in FIG. 7, it is desired to reduce the air flow rate of the air separation unit 60 when the temperature difference is small at the time of changing the controlled temperature, and increase the air flow rate as the temperature difference increases. In Embodiment 2, the rotation speed of the fan in operation was determined by using a table calculated from the condition of FIG. 7.

As illustrated in FIG. 6 with reference to FIG. 3, when the N^{th} recording medium requires the air separation (YES in Step S7), as shown in FIG. 7, the control portion starts the air cooling of the fixing roller 40 by setting, to the air separation unit 60, the air flow rate in accordance with the temperature difference between the controlled temperatures before and after the change. When the controlled temperature is changed immediately after the N^{th} recording medium has passed through the heating nip N, the lamp heater 40a is turned OFF, and thus the temperature of the fixing roller 40 is decreased at a speed corresponding to the air flow rate (Step S8).

Similarly, when the N^{th} recording medium does not require the air separation (NO in Step S7), as shown in FIG. 7, the control portion 80 starts the air cooling of the fixing roller 40 by setting, to the air separation unit 60, the air flow rate in accordance with the temperature difference between the controlled temperatures before and after the change. When the controlled temperature is changed immediately after the N^{th} recording medium has passed through the heating nip N, the lamp heater 40a is turned OFF, and thus the temperature of the fixing roller 40 is decreased at a speed corresponding to the air flow rate (Step S9).

Note that, FIG. 7 shows an operation condition of the air separation unit 60 when lowering the controlled temperature (Steps S8 and S9). However, it has been confirmed that also when increasing the controlled temperature (Step S5), setting the air flow rate of the air separation unit 60 in accordance with the temperature difference leads to a stable detected temperature of the thermistor 42a.

Subsequently, various types of combination image forming jobs were created, and then an effect of shortening a job execution time by the fixing roller cooling control according to Embodiment 2 was compared with those obtained in the cases of a conventional example and a dedicated fan. In control of the conventional example, the image forming apparatus 100 actuated the air separation unit 60 only in the above-mentioned usual operation mode without using the air separation unit 60 in cooling the fixing roller 40. In a configuration of the dedicated fan, a web cleaning device 55 illustrated in FIG. 2 was removed and a dedicated fan air cooling device such as the one described in Japanese Patent Application Laid-Open No. 2000-47521 was arranged instead. In order to compare with Embodiment 2, the air separation unit 60 was actuated only in the usual operation mode, and the fan air cooling device was set to blow to the fixing roller 40 an air at an equal rate and at a similar temperature to those of the air separation unit 60. As described above, in the actual fixing device 9, there are the web cleaning device 55 and the cover, and hence it is difficult to incorporate the air separation unit 60 and the fan air cooling device.

Results of comparison are shown in Table 2. Table 2 shows measured required time periods from a start of an image forming job to an end of the image forming job when various types of combination jobs were executed in the respective configurations and controls.

TABLE 2

| | Required time period | | |
|---|---|---|---|
| | Conventional | | |
| | Example | Embodiment 2 | Dedicated fan |
| Job A | 2 min 49 sec | 2 min 45 sec | 2 min 49 sec |
| Job B | 2 min 58 sec | 2 min 43 sec | 2 min 45 sec |
| Job C | 19 min 30 sec | 16 min 18 sec | 17 min 18 sec |
| Job D | 3 min 4 sec | 2 min 43 sec | 2 min 45 sec |
| Job E | 21 min 12 sec | 16 min 18 sec | 17 min 18 sec |

In Table 2, the job A is a combination job in which “fifty A4-size plain paper sheets of 300 g/m²” are continuously passed after “fifty A4-size plain paper sheets of 135 g/m²” are passed. The job B is a combination job in which “fifty A4-size plain paper sheets of 135 g/m²” are continuously passed after “fifty A4-size thick paper sheets of 300 g/m²” are passed. The job C is a combination job in which “five A4-size thick paper sheets of 300 g/m²” are passed after “five A4-size plain paper sheets of 135 g/m²” are passed and this is repeated ten times.

The job D is a combination job in which “fifty A4-size thin paper sheets of 70 g/m²” are continuously passed after “fifty A4-size plain paper sheets of 150 g/m²” are passed. The job E is a combination job in which “five A4-size plain paper sheets of 150 g/m²” are passed after “five A4-size thin paper sheets of 70 g/m²” are passed and this is repeated ten times.

The Job A involves one time of temperature change operation of increasing the temperature of the fixing roller from 170° C. to 200° C. at the 51^{st} sheet, and hence Embodiment 2 is advantageous by this amount. However, the difference is for only one time of temperature change operation, and hence as shown in Table 2, a time difference between Embodiment 2 and the conventional example is about four (4) seconds.

The Job B involves the temperature change operation of decreasing the temperature of the fixing roller from 200° C. to 170° C. at the 51^{st} sheet, and hence Embodiment 2 achieves an improvement over the conventional example by about fifteen (15) seconds.

In the job C, the controlled temperature of the fixing roller 40 is changed from 170° C. to 200° C. at 6^{th}, 10^{th}, 16^{th}, . . . , and 96^{th} sheets, and this change is executed for a total of twenty times throughout the job. A cooling time of several tens of seconds is required for a single temperature change, and hence, in the conventional example, it has taken about twenty (20) minutes. In Embodiment 2, owing to the cooling by the air separation unit 60, the required time is shortened by about 20 percent. In addition, in Embodiment 2, the required time is shortened even comparing with the “dedicated fan”. This appears to be because the air is continuously blown in Embodiment 2 so that a rising time for rotating the fan is not necessary, while the “dedicated fan” starts to rotate under a stopped state.

As for the job D, it was confirmed that as in the case of the job B, in which the controlled temperature of the fixing roller 40 is lowered from 200° C. to 170° C., the cooling by the air separation unit 60 is effective in the case in which the controlled temperature of the fixing roller 40 is lowered from 170° C. to 135° C.

As for the job E, it was confirmed that as in the case of the job C, in which the controlled temperature of the fixing roller 40 is increased from 170° C. to 200° C., the heating time shortening effect is produced in the case in which the controlled temperature of the fixing roller 40 is increased from 135° C. to 170° C.

When the job is not a combination job, i.e., when the recording media of the same type are continuously fed, the required time is the same for all the configurations. For example, in order to pass 600 thin paper sheets of 80 g/m², the image forming apparatus 100 having a throughput of 60 sheets/min takes ten point three (10.3) minutes including a time period of pre-rotation for preparing the image formation.

According to the configuration and control of Embodiment 2, the air separation mechanism and the fixing roller cooling mechanism, which are controlled separately in the case of the “dedicated fan”, can be unified as a single mechanism. The rising of rotation of the fan is faster, the control can be simplified, and the productivity can be improved.

According to the configuration and control of Embodiment 2, the same effect or greater as the configuration in which the dedicated cooling fan is provided can be achieved by operating the air separation mechanism at the time of cooling the fixing roller. In addition, the air separation mechanism is continuously operated in advance while turning ON the lamp heater during a fixing operation of a thin paper sheet when heating the fixing roller, the increase of the surface temperature of the fixing roller can be suppressed at the time of passing the thin paper sheet and a transition time to the controlled temperature of the thick paper sheet can be shortened.

According to the configuration and control of Embodiment 2, owing to the above-mentioned effects, a total productivity can be improved when various types of sheets are mixed.

### Embodiment 3

In the control of Embodiment 2, in order to avoid excessive cooling or temperature fluctuation of the fixing roller 40, the control portion 80 decreases the air flow rate of the air separation unit 60 as the temperature difference between the controlled temperatures before and after the change is smaller. When the controlled temperature of the fixing roller 40 is changed from a low controlled temperature to a high controlled temperature, a fan operation target temperature of the fixing roller 40 to be controlled is provided, and the operating condition of the air separation unit 60 is changed by comparing the fan operation target temperature and the temperature of the fixing roller 40.

However, as a temperature of the outside air is lower, the cooling performance with respect to the fixing roller 40 is increased, but in a usual air separating operation, there occurs a problem that the temperature of the fixing roller 40 cannot be maintained in a stable manner. In addition, as the temperature of the air becomes closer to the surface temperature of the fixing roller 40, the cooling performance may be decreased so that the cooling effect becomes insufficient.

In Embodiment 3 of the present invention, in addition to the control of Embodiment 2, the operating condition of the air separation unit 60 is changed in accordance with the temperature of the outside air or the temperature of the air input to the air separation unit 60. Excessive cooling of the fixing roller 40 is prevented by decreasing the air flow rate of the air separation unit 60 in the passing interval of the recording medium as the temperature of the air blown from the air separation unit to the fixing roller 40 is lower. It is matter of course that the air flow rate of the air separation unit 60 is not reduced on the recording medium to ensure the necessary air separation performance.

As described above, according to the configurations of Examples 1 to 3, through use of the air blowing device configured to separate the recording medium (also) as the air cooling mechanism for the fixing roller, the image forming apparatus is not upsized due to separate arrangement of the air blowing device. Therefore, the temperature can be converged to a lower controlled temperature after the change faster than in a case of using natural cooling without upsizing the image forming apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-181177, filed Aug. 23, 2011, which is hereby incorporated by reference herein in its entirety.

What is claimed is:

1. An image heating apparatus comprising:
an image heating member configured to heat an image on a sheet;
a heating device configured to heat said image heating member so that a temperature of said image heating member is kept to a target temperature;
an air blowing device configured to blow an air toward said image heating member when a predetermined sheet is separated from said image heating member; and
an actuating device configured to actuate said air blowing device to cool said image heating member by blowing the air when the target temperature of said image heating member is lowered.

2. An image heating apparatus according to claim 1, wherein when said actuating device actuates said air blowing device to cool said image heating member, said image heating member is rotated.

3. An image heating apparatus according to claim 1, wherein when said actuating device actuates said air blowing device to cool said image heating member, a heating operation performed by said heating device is stopped.

4. An image heating apparatus according to claim 1, wherein when the target temperature of said image heating member is lowered in accordance with change of a type of the sheet, said actuating device actuates said air blowing device to cool said image heating member.

5. An image heating apparatus according to claim 1, wherein the predetermined sheet comprises a sheet having a basis weight equal to or smaller than a predetermined value.

6. An image heating apparatus according to claim 1, wherein said air blowing device comprises an air nozzle having an opening located in a vicinity of said image heating member.

7. An image heating apparatus according to claim 1, further comprising a rotary member which forms a nip portion between said image heating member and said rotary member,
wherein said image heating member and said rotary member cooperatively fix an unfixed toner image, as the image, on the sheet at said nip portion by heat and pressure.

8. An image heating apparatus comprising:
an image heating member configured to heat an image on a sheet;
a heating device configured to heat said image heating member so that a temperature of said image heating member is kept to a target temperature;
an air blowing device configured to blow an air toward said image heating member when a predetermined sheet is separated from said image heating member; and
an actuating device configured to actuate said air blowing device to cool said image heating member by blowing the air when the target temperature of said image heating member is lowered in accordance with change of a type of the sheet while a plurality of sheets are continuously heated by said image heating member.

9. An image heating apparatus according to claim 8, wherein when said actuating device actuates said air blowing device to cool said image heating member, said image heating member is rotated.

10. An image heating apparatus according to claim 8, wherein when said actuating device actuates said air blowing device to cool said image heating member, a heating operation performed by said heating device is stopped.

11. An image heating apparatus according to claim 8, wherein the predetermined sheet comprises a sheet having a basis weight equal to or smaller than a predetermined value.

12. An image heating apparatus according to claim 8, wherein said air blowing device comprises an air nozzle having an opening located in a vicinity of said image heating member.

13. An image heating apparatus according to claim 12, further comprising a rotary member which forms a nip portion between said image heating member and said rotary member,
wherein said image heating member and said rotary member cooperatively fix an unfixed toner image, as the image, on the sheet at said nip portion by heat and pressure.
